(19) United States
(12) Patent Application Publication
(10) Pub. No.: US 2014/0019202 A1
(43) Pub. Date: Jan. 16, 2014

(54) METHOD FOR COLLECTING INFORMATION, COMPUTER PROGRAMME PRODUCT AND BUSINESS MODEL THEREFOR

(71) Applicants: Jozo Mamic, Berlin (DE); Petr Nemec, Berlin (DE); Dietrich Von Richthofen, Berlin (DE); Serafin Von Roon, Munchen (DE); Jan Stütz, Berlin (DE); Henning Thienemann, Berlin (DE)

(72) Inventors: Jozo Mamic, Berlin (DE); Petr Nemec, Berlin (DE); Dietrich Von Richthofen, Berlin (DE); Serafin Von Roon, Munchen (DE); Jan Stütz, Berlin (DE); Henning Thienemann, Berlin (DE)

(21) Appl. No.: 14/007,491

(22) PCT Filed: Mar. 26, 2012
(86) PCT No.: PCT/EP12/01323

§ 371 Date: Sep. 25, 2013

(30) Foreign Application Priority Data
Mar. 25, 2011 (DE) PCTDE2011075050

(51) Int. Cl. G06Q 30/02

(52) U.S. Cl. CPC G06Q 30/0201
USPC 705/7.29

(57) ABSTRACT

A method for providing and collecting information via crowdsourcing by means of an Internet browser, includes providing a first memory location and at least two memory sublocations liked thereto on a server. The first memory location is writable with data by a first group of users via an Internet browser the first group of users loads a description of a searchable object into the first memory of the server. The memory sublocations can be written with data by a second group of users, to provide information that applies to the searchable object.

It is well-known from the state of the art to apply crowd-sourcing methods to look for relevant prior art which is used for the evaluation of the patentability of patents. US 20080270255 A1 reveals such a method. Further such methods are known from the so called Peer-to-Patent model.

The disadvantages which result from the state is that it comes to mismatching and too few substantial search results, if the searcher of the crowd-sourcing is not trained in regards to legal matters of patentability because of the fact that patents are written linguistically very complicated which is difficult to understand.

It is a subject to this invention to provide a method, a business method and a computer program product, which prevents or diminishes the disadvantages caused by the state of the art.

This task is solved with method comprising the steps of claims 1, 16 and/or 17. Further favorable embodiments of the invention are disclosed by steps of the depended claims. The method for making available and collecting information by means of an internet browser comprises thereby the following steps:

Making available on a server one first memory location and at least two sub-memory locations, wherein the sub-memory locations are assigned to the first memory location, and wherein the first memory location is writable with data by a first user group using an internet browser. For describing a product or method verbally and to display it on an internet browser the first user group loads a description of the subject which shall be searched into the first memory location of the server. Preferably the only the first user group is equipped with rights to write for this first memory location.

The first and second sub-memory location can be written with data by a second user group using an internet browser. The searching user—namely the searcher of the crowd-sourcing—provides information which matches with the subject which is to be searched. A completion signal can be made available by the searcher by pressing a button “send”. If this happens, the input in the first and second sub-memory locations is saved on the server by said user.

Preferably the first sub-memory location can only be written with pre-defined values or the description can be validated by pre-defined values. These pre-defined values are specified by the first user group, thus e.g. by the administrator of the internet site. In particular, quantitative numeric values like “0, 1, 2 or 3” can be assigned to the pre-defined values of the first sub-memory location. Thus the user is only able to insert those values when he enters suitable information relevant to the subject to be searched into the first sub-memory location. These values represent the extent of matching of the entered information with the search subject; for example “0” for no match; “1” for a non-explicit match but it is obviously disclosed from the overall context; “2” for a match is based on a similarity, and “3” if the indicated information literally matches the search subject or is essentially the same with the search subject.

Besides this the inventive method reveals that a first file storage location is provided on the server which is assigned again to the first memory location and to the first and second sub-memory locations. The crowd-searcher can upload the piece of evidence on this file storage location which contains the information matching with the search subject. This piece of evidence can be a text document, a pdf-document, a picture, a movie or any other type of file.

The second sub-memory location is used for providing the cross reference between the matching degree and the provided information source respectively evidence. For example the user can enter specific data related to the evidence like page, column or line number in that second sub-memory location.

Preferably the user can only provide the completion signal if a piece of evidence or information is uploaded into the first file storage of the server and if a matching degree is indicated in the first sub-memory location representing the match between the information and the search subject and if the cross reference is entered in the second sub-memory location.

A preferred embodiment of the inventive method discloses to provide a third sub-memory location on the server. The third sub-memory location is assigned to the first memory location. Only a administrator of the first user group may write on the third sub-memory location by using an internet browser. Preferably the data of the third sub-memory location are quantitative, numeric values.

In order to be able to describe a search subject by a plurality of single elements it is disclosed by a further preferred embodiment to provide a second and/or a further memory location on the server which is analogous to the first memory location. In particular the additional memory location comprises at least two sub-memory locations, and/or also a third sub-memory location. The first file storage location specified above is assigned also to the second memory location and if necessary to the further memory location, too. Thus a list can be created whereby single elements of the search subject are described or displayed by the individual memory locations. Then the following step can be executed: Work on, formatting and/or preparing the data at least of the first memory location, but in particular also of the second and/or the further memory locations. This is done in such that the data can be presented in a list form in an internet browser. Further there is working on, formatting and/or preparing the first and second sub-memory locations, but in particular also the sub-memory locations of the second and/or of the third and/or further memory location in such manner that these are presented as input field in a list form in an internet browser. Each input field is respectively assigned to the first, second and/or further memory location.

Preferred a second file storage location for storing one or several files is provided on the server assigned to all or to selected memory locations. On this second file storage location graphic descriptions or written descriptions related to a single element or to all elements of the search subject can be saved. Preferably this may only be done by the administrator. Obviously a plurality of file storage locations for graphic elucidation for each search subject can be provided.

Also a computer program product is disclosed which enables on a server the execution of said method. Further preferred embodiments are disclosed by the dependent claims.

The method provides the possibility to offer an innovative service by which companies can defend themselves better against unjustified patent claims or against infringer of own protective rights. This method is made for all medium-size and larger companies, which are limited in regards to their freedom to operate by (allegedly illegitimately granted) patents or whose protected products, innovations, marks or designs are copied.

The cancelation of a blocking protective right, e.g. a patent, is economically desirable for companies in several respects: Risk provisioning formed for possible patent infringements proceedings are set free. Royalty payments are omitted. Earlier protected markets become accessible. In some cases individual companies may save seven figure amounts or more—blocking patents can be crucial in regards to their existence.

Questioning the validity of hindering patents is legitimate and a usual measure in the world of protective rights. For this companies perform searches for professional specific documents which prove the patent in question was not justified granted. Due to the existence of many different technical fields and due to the growing globally distributed knowledge the classic patent searcher is less and less enabled to access all possible relevant sources.

Also, damages by product piracy increase continuously. With the help of its group of users of the crowd searchers the internet platform provides necessary evidence for uncovering patent infringements thus for protecting innovations of its clients and for enforce related damage claims.

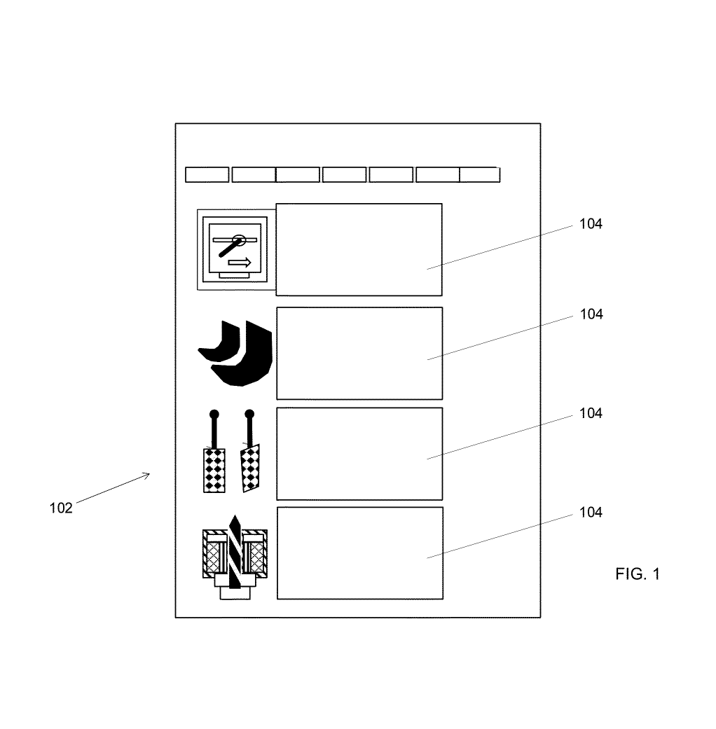

At this point the method and the business comes in: The search subject 104 of the search request 104 of the customer, e.g. a company, is made accessible to a global community of specialists—the crowd-searchers—via an internet platform 102 (FIG. 1). In relation to classical patent searches the probability to find e.g. the documents relevant for a successful patent defense increases enormously.

So far, similar services are offered only in the US market. In those cases the search subject is published by the patent specification in its original wording. Thus the information is accessible only for patent specialists who are familiar with the jargon of the patent. For the success of the search services described above the straight integration of technical experts who cannot deal with “Patent Latin”, is crucial.

The market environment in which the method and/or the business model is applicable represents a very solid growth oriented starting point. According to an estimation of the Deutsche Bank in the year 2010 the world-wide business volume of trading with patents will reach a value of 500 billion US Dollar, tendency further rising. An increasing number of patent applications and the rising number of the patent litigations are pushing the demand for service of the patent searches.

The method and the business model of the operator consist in providing a web platform by which high quality searches can be executed for companies or other participants wherein the searches can be a prior art search or other search subjects, in particular for evaluation the validity of protective rights and/or a patent but also for other purposes like for uncovering infringements of protective rights. FIG. 1 shows an example the internet site 102. The searcher sees apart from information about patents or protective rights, messages and a personal account instantly the newest search requests 104. The search requests 104 have a file reference number.

The key to success is that via the internet sufficient searcher can be recruited for the search request by means of crowdsourcing. The pool of the searchers consists of technical experts of different fields, relevantly interested laymen and patent specialists. The individual searcher of the community is carefully instructed by the internet site and does therefor not need to have profound knowledge of the complex patent field. Searchers all over the globe can involve themselves for searches.

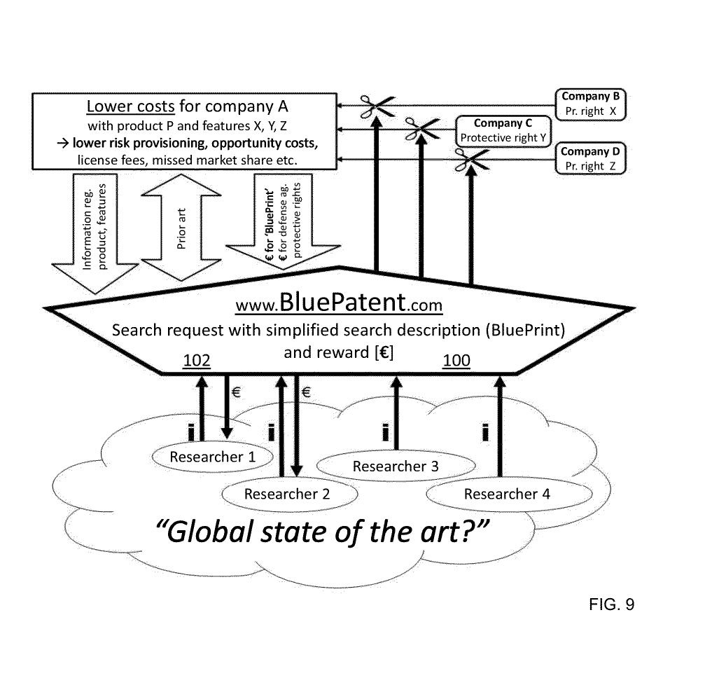

By FIG. 9 a typical operational sequence of a successful business operation is described and the most important participants of this business operation are graphically shown. With the help of arrows the essential flows of information and funds and their direction are made visible. Additionally the most important client benefit—the cost savings—is included as central point. This represents the main motivation for potential clients/customers to participate in the method and business model and to place an order at the internet site of the operator:
i. Company A is substantially limited by the protective right X of the competition company B. Company A would like to actively challenge this and therefor approaches the operator.
ii. Together with company A the operator analyzes the protective right X of the opponent.
It is specified to which extend this third protective right shall be limited, at which point a search is to be interpreted as successful or partly successful and the amount of the success-dependent remuneration is specified, too. The height depends on the risk provisioning, royalty payments and/or on the litigation value of ongoing patent infringement proceedings. The height shall be negotiated individually and specified by a contract.
iii. Company A pays an initial lump sum to the operator. The operator creates a search request 104 for the protective right X respectively for the challenged patent claims by providing form for comparison 100. The patent claims of the protective right X to be challenged represent the search subject which is split up into several, easily understandable single elements which in its whole exactly represent the search subject. If now the operator provides the form for comparison 100 to the search subject in the search call 104 he applies embodiments of the methods mentioned above.
iv. This search request 104 including the form for comparison is published on the internet site 102 of the operator.
v. Beside, a reward is offered which is paid to successful searchers. A searcher is deemed to be successful if the information investigated is suitable for fulfilling the goals defined in the contract agreed on with company A, i.e. if the extent of protection or the protective effect of the above mentioned protective right becomes substantially limited or eliminated.
vi. The operator hands over the contents to the search to company A or publishes in arrangement with company A this content on the internet site 102. By the re-valuation of the protective right the client company A can release risk provisioning, re-negotiate license agreements or successfully win invalidation proceedings.
vii. If the success criteria negotiated with company A are fulfilled the operator receives a bonus which was negotiated earlier with company A.
viii. The operator disburses the offered reward and the benefits to the successful searcher. If necessary the operator regularly pays out a benefit to his most active searcher.

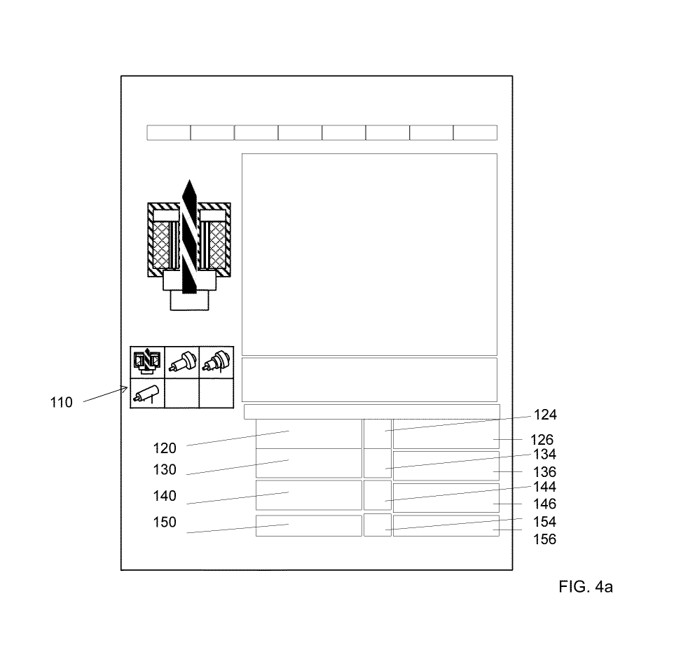

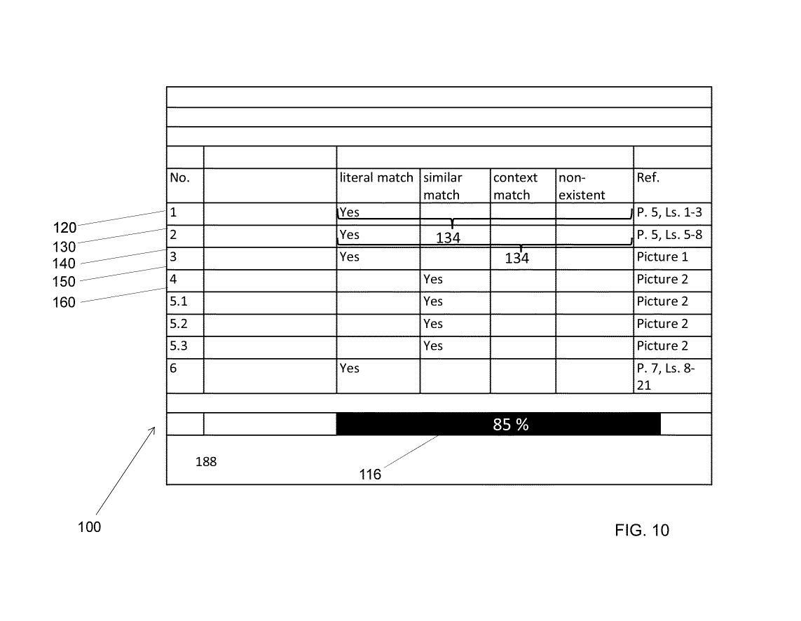

The core of the invention, the method, and/or the business models lies in the development of the search call 104, in particular in the form for comparison 100 for the search subject. This form for comparison 100 is called BluePrint. Basically a first embodiment of the the form for comparison 100 is shown in FIG. 4. FIG. 10 discloses a second embodiment.

By this method and its application it is possible to represent, explain and to answer the single elements 120 of the search subject in a structured way. The BluePrint provides the possibility thereby to the users, i.e. to the crowd searchers to compare their information searched via an internet site point by point with the contents of a patent, without even having seen or understanding the patent. By this comparison function, which additionally can evaluate the results with mathematical algorithms, even a patent layman can analyze whether its documents searched are relevant. The BluePrint 100 is a table style description of the search subject and/or the patent claim but has no patent technical and difficult language. This BluePrint 100 is a translation of the patent claim into a language understandable for patent laymen.

The individual elements 120, 130, 140, 150, etc. of a search subject can come with technical explanations in the BluePrint 100, with so called “pop ups” (in FIG. 10 represented in the form of footnotes 188) or also with hyperlinks to e.g. Wikipedia. Further also figures and representations are provided which additionally describe the search subject. In FIG. 10 single elements of the BluePrint are written in text form (not shown) and provided with footnotes 188. In the lower area the footnotes 188 are provided with explanations.

It' a goal to motivate the technical expert knowing the search subject by making the approach to the search subject as easy and entertaining as possible and by reducing the initial work effort as much as possible. Thus it is ensured that also the searcher not fully skilled in patent topics—the patent layman—can understand the search subject.

The developed form for comparison 100, if necessary the developed algorithms and the community of the searchers and/or users are used for enforcing the protective effect of protective right, like patents, brands, and designs. For this companies can upload specifications and pictures of its protected products or methods to the internet site of the operator. The search community looks for plagiarisms of these products and supplies the evidences (e.g. purchase proofs, catalogs) for an infringement of the protective right. In the following the general method is now described step by step:

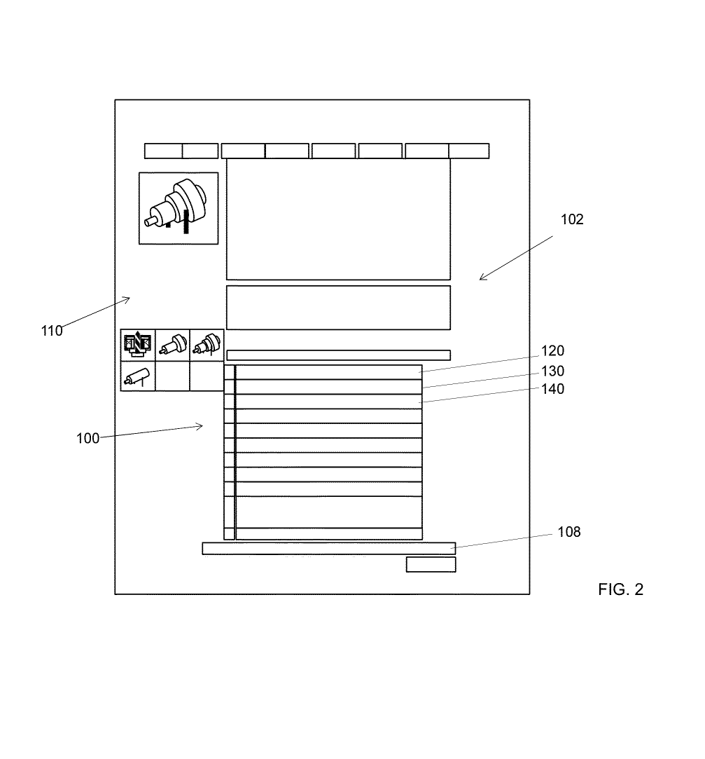

In a first step a search subject, a patent claim 104a of a patent or also a assumed infringing subject 104b is presented and published by its single elements 120, 130 in tabular form (FIG. 2). According to an embodiment the searcher must register as user for being allowed to use the writable BluePrint 100 in accordance with FIG. 4 and FIG. 10. Prior to this the searcher can use a non-writable version of the BluePrints. This is represented in FIG. 2.

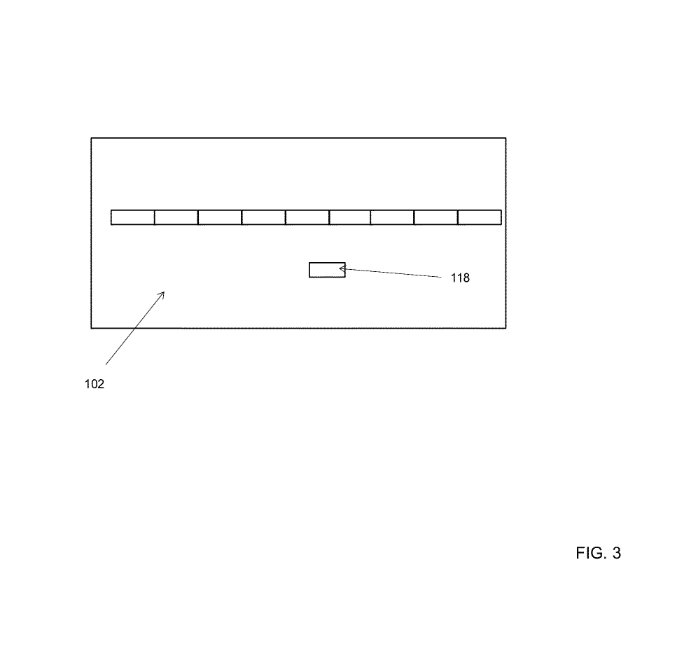

If the searcher knows a document or circumstances which matches on the search subject, in a next step the searcher can upload the evidence of those circumstances like photos, bills or published documents to the internet site of the operator. FIG. 3 discloses an internet site for uploading a document and a button 118 for uploading.

FIG. 4 and FIG. 10 shows the search request 104 having the writable form for comparison 100. The searcher is enabled to compare his own search results step by step in a structured way with the single elements 120, 130 of the search subject. Further the searcher can provide the degree of matching of of the search results to with the single elements by providing a respective input in first sub-memory 124, 126—and the respective reasoning for the matching by providing a respective input in the appropriate second sub-memory 134, 136.

Thus, the searcher can now indicate to each element of the tabular BluePrints 100 to what extent—according to himself—his search result matches with the search subject. For this selection fields 124, 134 for instance: “literally”, “similarly”, “in the context” “no indication” are available. By this the searcher can indicate his assumption about the matching degree between the search results with the search subject. This is shown in FIG. 4a and in continuation in FIG. 4b or FIG. 10. With the help of this automated element comparison—thus with the BluePrint—the searcher can analyze independently whether its searched documents are relevant.

The BluePrint 100 comprises not only a simple, structured, list style description of the search subject but also may provide a feedback function for the searcher. As result the searcher can receive a value, e.g. a qualitative progress value in form a progress bar 116 (FIG. 10) or progress “speed meter”, or a specific percentage which reflects the degree of matching (not shown).

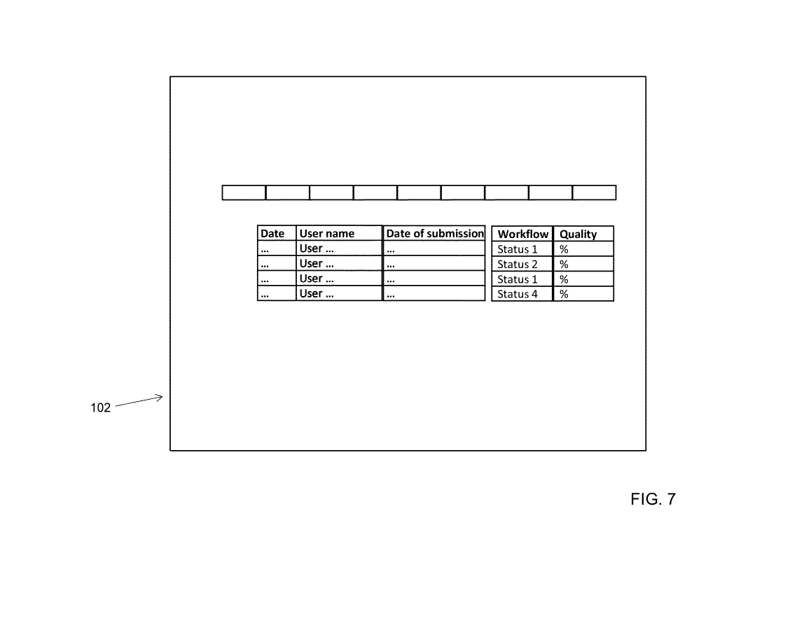

This comparison between the patent specification in question and the searched document is based on a carefully thought out algorithm which represents the substantial intellectual property of the operator. A weighting 128 of the single elements 120, 130, 140, etc. is also possible. As a result of this automated method the technical administrators of the BluePrints 100 can easily perform a pre-selection of the number of search results. For sure, high relevant search results must be reviewed again by the patent experts of the operator. FIG. 7 shows an overview of different search submissions of different searchers. In particular the quality of the different submissions is indicated and is linked to a user. Depending upon each submission the work flow and/or a status of the submission is adapted.

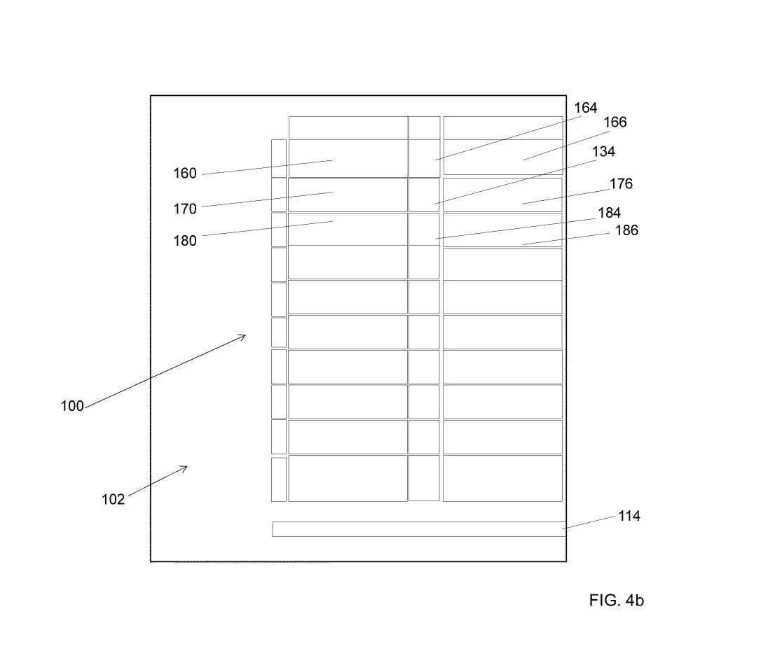

After the searcher filled out and sent the BluePrint 100 he gets a receipt confirmation (FIG. 5). This can also be happen via email.

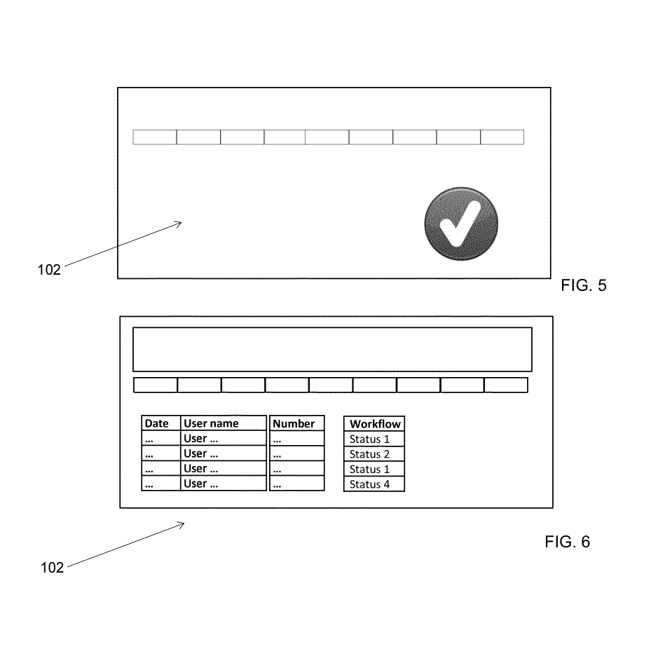

In the personal account area the searcher has an overview about all his submission and further a review and work on can be done of those (FIG. 6). The searcher sees all his submissions and a respective status, shown in FIG. 6 in the table and columns.

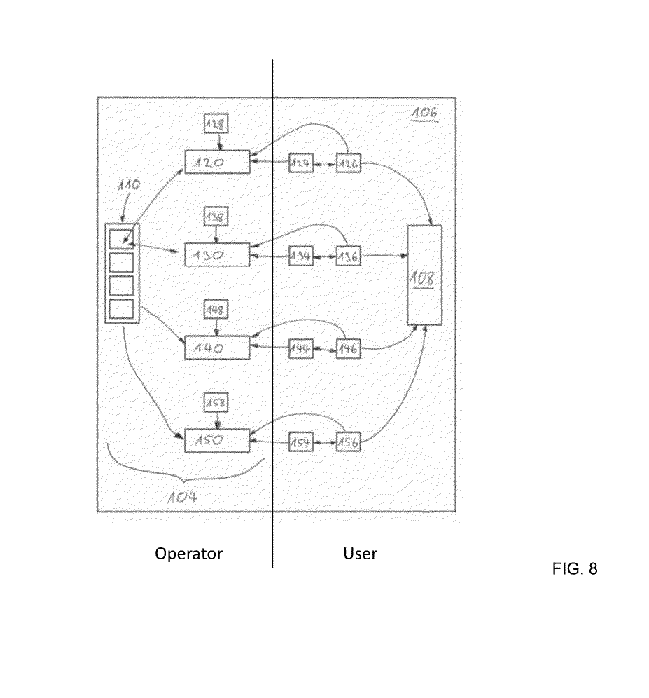

FIG. 8 describes the technical structure of the invention. A first memory location 120 is provided on a server 106. This first memory location 120 corresponds to one single element (e.g. point 2.3, FIG. 4) of the BluePrint 100. This can be put on by administrators of the operator. Two further sub-memory locations 124, 126 are assigned to this first memory location 120 on the server 106. The sub-memory locations 124, 126 correspond to the input fields in FIG. 4, which can be filled out by the searcher, thus the user. In the first sub-memory 124 the degree of matching is entered. This can happen in differently. In this case entering the values “1” stands for literal match, “2” for a similar match, “3” for a contextual match and “4” for no match. The sub-memory 3 is provided with a routine for the examination of the validity of the entering which gives back an error message if a value is entered not equal to 0, 1, 2, 3.

It is possible that the user does not have to enter numerical values here but can select pre-specified terms wherein in internal allocation to values takes place. Relevant to this invention is that numerical values are assigned to these indication of match.

The second sub-memory 126 corresponds to the input field in FIG. 4 or FIG. 10 in which the user indicates the exact location of the match in the uploaded document or piece of evidence. Free text can be used here. Preferably the search request 104 cannot be saved if there is no values larger than zero is entered in each sub-memory locations 124 and if there is no input present in the sub-memory location 126. By this the submission of incomplete filled out forms for comparison 100 is prevented.

Further a third sub-memory location 128 assigned to the first memory location 120 can be provided on the server 106. The user may not see this. For the administrator of the operator who provides the search request 104 and the BluePrint 100 this is of highest importance. Because here a quantitative weighting 128 of the respective single element 120 in relation to the other single elements 130, 140 of the search request 104 can be entered.

In order to create a search request 104 with a plurality of single elements—e.g. according to the example shown in fig. to 4 having twelve elements—twelve memory locations 120, 130, 140, 150, 160, etc. are required. Analogous to the memory location 120 at least two sub-memory locations 124, 126 and 134, 138—thus in sum twenty-four sub-memory locations pursuant to FIG. 4—are assigned to each memory location 120, 130, 140, 150, 160, etc. According to a favorable embodiment also third sub-memory locations 128 and 138 (and further) can be provided in order to save weightings of each element.

A first file storage location 108 is provided on the server 106 which is assigned again to the first memory location 120 and to the first 124 and second sub-memory locations 126 or which can, if necessary, be assigned to all of the memory locations 120, 130, 140, 150, 160, etc. On this file storage location 108 the crowd-searcher can upload the piece of evidence which contains the information match with the search subject. This piece of evidence can be a text document, a pdf-document, a picture, a movie or any other type of file.

A second file storage location 110 for storing one or several files is provided on the server 106 assigned to all 120, 130, 140, etc. or to selected memory locations. On this second file storage location graphic descriptions or written descriptions related to a single element or to all elements of the search subject can be saved. Preferably this may only be done by the administrator. Obviously a plurality of file storage locations for graphic elucidation for each search subject can be provided.

It is also possible to provide a third or fourth file storage location on the server 106 and that—beside the first and second sub-memory location—another third and fourth sub-memory location are assigned to each memory location in such that the searcher can upload more than only one piece of evidence to each search request on a further file storage location. Thus a form for comparison could be provided which enables the comparison of several evidence documents with the single elements. By this also the question of obviousness during the patent prosecution or contributory patent infringements could be worked on and evaluated by the crowd-searchers.

The single embodiments shall not limit the extent of the invention itself, on the contrary the single element of the embodiments can be combined—as long as such combination makes sense—with each other.

1. A method for providing and collecting information using an internet browser, comprising the following steps of:
providing a first memory and at least a first and second sub-memories on a server,
wherein the sub-memories are linked to the first memory,
and wherein the first memory is writable with data by a first user group using an internet browser,
and the first and second sub-memory are writable with data by second user group using an internet browser, wherein the second user group can provide a completion signal;
writing data on the first memory by the first user group;
providing, editing and/or formatting the data of the first memory in such a manner that the data in can be displayed in an internet browser;
performing an automatic storage process of the data in the first and second memory,
wherein the storage operation is initiated by the completion signal.

2. The method according to claim 1 comprising the steps of:
writing on the first and the second sub-memories by the second user group;
providing a completion signal of the description method by the second user group.

3. The method according to claim 1, wherein
the first sub-memory is only writable with pre-defined values, or that the description can be validated by pre-defined values,
wherein the pre-defined values are specified by of the first user group.

4. The method according to claim 1, wherein quantitative, numeric values are assigned to the pre-defined values of the first sub-memory.

5. The method according to claim 1, comprising the steps of:
providing a third sub-memory on the server,
whereby the third sub-memory assigned to the first memory;
writing on the third sub-memory by the first user group over an internet browser.

6. The method according to claim 1, wherein the data of the third sub-memory are quantitative, numeric values.

7. The method according to claim 1, comprising the steps of:
providing on the server at least a second memory,
with at least first and second sub-memories,
and optionally a third sub-memory linked to the second memory
wherein the first and second sub-memories linked with the second memory are writable with data by the first user group;
writing on the second memory by the first user group,
wherein the first and second sub-memories of the second memory is writable with data by the second user group using an internet browser,
wherein with data, a completion signal can be provided by second user group;
executing an automatic data saving process in the respective first and second sub-memories of the first and the second memories of the server, and analogous to the embodiment and handling to
wherein the data saving process is initiated by the completion signal.

8. The method according to claim 1, comprising the step of: Providing on the server, at least a third memory which is analogous to the embodiment, handling and processing to the first and/or second memory.

9. The method according to claim 8, comprising the steps of:
processing, formatting and/or preparing the data of the first memory, second memory and third memory in such that the data can be presented in list form in an internet browser;
processing, formatting and/or preparing the data of the first and second sub-memories of the second and/or memory in such manner that these are presented as input field in a list form in an internet browser.

10. The method according to claim 8, comprising the step of: Processing the values of the second sub-memory locations respective first, second and third memories such that a total value is produced, which totally represents the values of all the respective second sub-memories by calculation the average of all values of such second sub-memories.

11. The method according to claim 8, further comprising respective third sub-memory locations for each of the first, second and third memories comprising the step of: Processing the values of the second sub-memory locations with the values of the third sub-memory locations of all of the memories in such that a total value is produced which totally represents the values of all the second sub-memories, by calculation the average of all values of the second sub-memory locations.

12. A method according to claim 11, wherein the first, second and/or third memories and/or each of the third sub-memories which are assigned to the respective first, second and/or third memories are equipped with rights to write data such that the first, second and/or third memories and/or each of the respective third sub-memories can only be written on by the first user group.

13. The method of claim 1, wherein the first and second sub-memories are equipped with rights to write data such that the respective first and second sub-memories can only be written on by the first and second user group.

14. The method of claim 5, comprising the steps of:
providing at least a first file storage on the server, wherein this file storage is commonly assigned to the first memory and the second memory or to the first, second and further memory;
providing a routine to upload a data file into the file storage by means of an internet browser.

15. The method according to claim 1, wherein the completion signal can only be generated if a file was uploaded on the file storage on the server.

16. The method according to claim 1, comprising the steps of:
providing at least a second file storage on the server, wherein this file storage is assigned to the first memory or to the first and second memory or to the first, second and third memory;
providing a routine to upload a data file into the file storage by means of an internet browser by the first user group.

17. Computer programme product for the execution of the method according to claim 1.

18. The method according to claim 1 comprising the steps of:
publishing of a search request in the internet using an internet platform, while the search request comprises a detailed description of a search subject,
wherein the single elements of the search subject are inquired by the help of a form for comparison and input in such manner that a searcher is instructed to perform a structured comparison of an own searched topic with the search subject of the search request.

19-22. (canceled)

23. The method according to claim 18, wherein the totally or partly filled out form is evaluated manually or computer supported in what extend the search request matches with the own searched topic.

24-25. (canceled)

26. The method according to claim 23, wherein the different and partially filled out forms are combined by computer support for arriving at the search subject of the search request by two own searched topics.

27-30. (canceled)
